(19) United States
(12) Patent Application Publication
(10) Pub. No.: US 2005/0106976 A1
(43) Pub. Date: May 19, 2005

(54) Composite mat

(76) Inventor: Cyriak Laner, Neuhaus/Inn (DE)

Correspondence Address: LADAS & PARRY LLP, 224 SOUTH MICHIGAN AVENUE, SUITE 1200, CHICAGO, IL, 60604, US

(21) Appl. No.: 10/482,622

(22) PCT Filed: Apr. 30, 2003
(86) PCT No.: PCT/DE03/01390

(30) Foreign Application Priority Data
Apr. 30, 2002 (DE) 102 19 459.9

(51) Int. Cl. B32B 27/12; D03D 15/00

(52) U.S. Cl. 442/286; 442/189

(57) ABSTRACT

The invention relates to a composite mat (1) comprising a rough structured surface on the upper side and a smooth closed-planar, watertight surface on the underside. Said composite mat consists of two layers, which are joined to one another, in particular, by welding, adhering or a similar technique, namely of an upper layer made of a woven material (3) and of an underlayer made of an elastic synthetic material (2).

The present invention relates to a composite mat, in particular made of a synthetic material, and in particular for use in agriculture.

In particular for use in agrarian technology, synthetic mats or synthetic sheets are known in different thicknesses of typically about 0.5 mm or lower, whose mechanical and chemical properties are sufficient to meet general requirements of agriculture. Such mats are resistant against the influence of ultra-violet light and weather resistant; therefore, even in outdoor enviroments they have a high lifetime of several ten years against weather related and mechanical treatment. The mats are closed-planar and watertight, and have a smooth surface. For certain use, e.g. as top layer of a cow mat, the presentation of the surface, namely the smooth surface is disadvantageous or not wished. A smooth surface is not sliding-safe, and offers merely a bad hold of litter, and has only a low thermical insulation effect. Moreover, liquid may be collected on the surface, which at least does not get dry fast enough, resulting in an increase of a danger of slipping. In order to remove such disadvantages it is known to use an additional mat cover having a slide-safe area on the upper side. This, however, increases the constructive expenditure.

It is an object of the present invention to provide for a composite mat and a method for its producing, which mat is sufficient for the high mechanical and weather related requirements existing in the agrarian technology field, i.e. is UV- and weather resistant, absolutely watertight, enough deformable and elastic for a longer period, and is stable against pressure forces, and at the same time has a slide-safe and up to a certain degree liquid-sucking surface, and in addition may be produced easily as well as with low costs.

This object is solved by a composite mat according to claim 1, a method for producing a composite mat according to claim 10, and further by a use of the composite mat according to claim 11.

The present invention offers a composite mat with a rough structured surface on the upper side and a smooth closed-planar watertight surface on the under side, said composite mat consisting of two layers, which are joined to one another, in particular by welding, adhering or a similar technique, namely of an upper layer made of a woven material and of an under layer made of an elastic synthetic material.

The upper side of the inventive composite mat is slide-safe due to its structured surface extending on a larger area of the surface, and due to its properties allowing a liquid-sucking at least to a certain degree. Due to its larger part of surface of the upper side and respectively the surface area the upper side has, there is a better drying of liquid collected on the upper surface, and also a better hold of litter or similar means used in agriculture. In addition, the thermical insulation is improved due to the structured upper surface on the upper side of the composite mat. The under layer which consists of elastic material compounds well with the woven material of the upper layer, so that there is an excellent adhesion between upper layer and under layer. As a result, there is achieved an intense compound of the liquid-tight under layer with the open structure of the upper layer. The under layer is closed-planar and absolutely watertight.

Following the principle of the invention there could be further provided that the type of tissue of the tress tissue and respectively ribbon tissue constitutes a diagonal web bond in a plaited form. It is further advantageous when the woven fibres of the upper layer are turned or twisted.

Further advantageous features are indicated in the subclaims.

The inventive method for producing a composite mat comprising a rough structured surface on the upper side and a smooth closed-planar watertight surface on the under side is characterized in that the composite mat is produced by two layers, which are joined to one another, in particular by welding, adhering or a similar technique, namely by an upper layer made of a woven material and an under layer made of an elastic synthetic material.

In a further aspect of the invention, the method is characterized in that the compound of said tissue-like upper layer and said sheet-like under layer is effected by a high temperature bond method, by which the still warm ductile under layer immediately after extrusion is applied on said woven material of said upper layer fixedly joined within said tissue material. Thereby, a very good compund between upper layer and under layer is achieved.

Further characteristics, advantages and features of the invention are disclosed in the following description of embodiments with respect to the drawings. It shows:

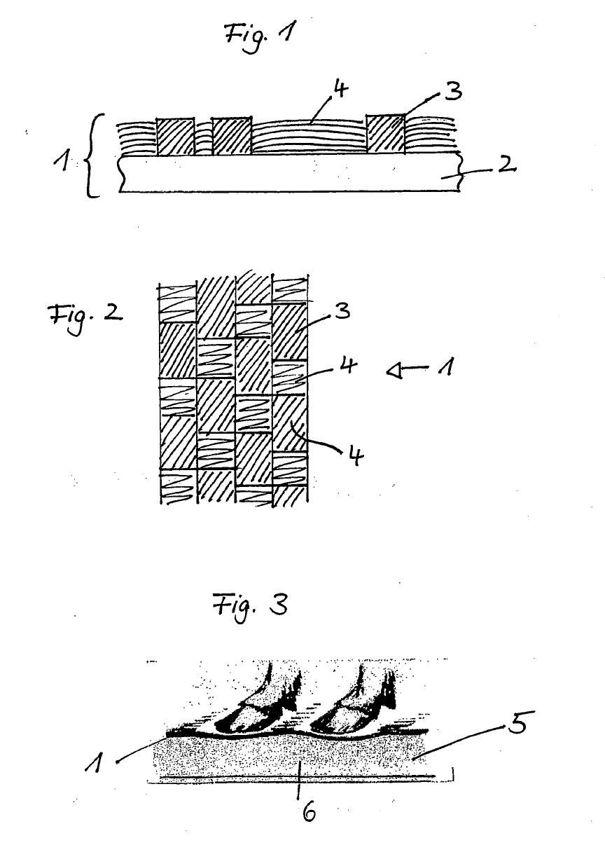

FIG. 1 a schematic sectional view in enlarged representation of the inventive composite mat;

FIG. 2 a schematic plan view in enlarged representation of the inventive composite mat; and

FIG. 3 a schematic view of a cow mat having a cover consisting of the inventive composite mat.

The embodiments shown in FIGS. 1 and 2 comprises a inventive composite mat 1 consisting of two layers, which are joined to one another, in particular by welding, adhering or a similar technique, namely of an under layer 2 made of a elastic synthetic material and of an upper layer 3 made of an woven material. The under layer 2 is a closed watertight polypropylene sheet with a thickness of 0.5 mm to 1.5 mm, preferential 1.0 mm. The upper layer 3 consists of a polypropylene or polyethylen tress tissue with a thickness of 1.5 mm to 1.9 mm, preferential 1.7 mm. The tress tissue constitutes a tress tissue, in particular a ribbon tissue, wherein the type of yarn of the woven fibres 4 is splace yarn. The kind of tissue of the tress tissue of the upper layer 3 constitutes a diagonal web bond in a plaited form. In particular, the woven fibres 4 of the tress tissue of the upper layer 3 are turned.

Both layers 2 and 3 of the composite mat 1 constitutes the same synthetic material, namely polypropylene or polyethylen. Therefore, a good and consistent compound of under layer 2 and upper layer 3 of the composite mat over all the surface is achieved. From external view it is not noticeable that the composite mat 1 consists of two layers with different structure; the composite mat 1 appears a mat of a standarized material, wherein the upper surface on the upper side of the mat 1 is rough and structured, and the upper surface on the under side of the mat 1 is smooth, closed-planar and watertight.

FIG. 3 shows a preferred use of the inventive composite mat 1 with a cow mattress 5, which mainly consists of a covering layer comprising the inventive composite mat 1 and a mat filling 6 consisting of e.g. a clear sieved rubber granulate having a granularity of 3 mm to 6 mm. The covering layer formed by the inventive composite mat 1 offers a slippery-free upper side, while the under side is laminated absolutely liquid-tight. When entering the laying area by the animals the mat filling 6 gives way, while the structured upper surface of the covering layer gives a slide-safeness even in case of wetness or dirt. Because of the wetness-tight covering layer the mat foundation stays dry and steril. The mat cover may be easaly cleaned with a high-pressure cleaner without problems.

1. Composite mat (1) comprising a rough structured surface on the upper side and a smooth closed-planar watertight surface on the under side, said composite mat consisting of two layers, which are joined to one another, in particular by welding, adhering or a similar technique, namely of an upper layer made of a woven material (3) and of an under layer made of an elastic synthetic material (2).

2. Composite mat (1) according to claim 1, characterized in that the upper layer (3) consists of a tress tissue, in particular a ribbon tissue, wherein the type of yarn of the woven fibres (4) is splace yarn.

3. Composite mat (1) according to claim 2, characterized in that the kind of tissue of the tress tissue or ribbon tissue comprises a diagonal web bond in a plaited form.

4. Composite mat (1) according to claim 2 or 3, characterized in that the woven fibres (4) of the tress tissue or ribbon tissue of the upper layer (3) are turned.

5. Composite mat (1) according to one of the previous claims, characterized in that the woven fibres (4) of the tissue material of the upper layer (3) are made of polypropylene or polyethylen.

6. Composite mat (1) according to one of the previous claims, characterized in that the upper layer (3) has a thickness of 1.3 mm to 3.3 mm, in particular 1.5 mm to 1.9 mm, and especially 1.7 mm.

7. Composite mat (1) according to one of the previous claims, characterized in that the upper layer (3) has an area density of about 360 g/m² to 940 g/m², and in particular of about 500 g/m².

8. Composite mat (1) according to one of the previous claims, characterized in that the under layer (2) is a closed watertight polypropylene or polyethylen sheet having a thickness of 0.5 mm to 1.5 mm, especially 1.0 mm.

9. Composite mat (1) according to one of the previous claims, characterized in that the under layer (2) has a tear strength of about 17 N/mm² (according to NEN ISO 527), a breaking elongation of >800% (according to NEN ISO 527), and a further tear strength of more than 40 N/mm² (according to DIN 53515).

10. Method for producing a composite mat (1) comprising a rough structured surface (3) on the upper side and a smooth closed-planar watertight surface (2) on the under side, characterized in that the composite mat (1) is produced by two layers, which are joined to one another, in particular by welding, adhering or a similar technique, namely by an upper layer made of a woven material (3) and an under layer made of an elastic synthetic material (2).

11. Method according to claim 10, characterized in that the compound of said tissue-like upper layer and said sheet-like under layer is effected by a high temperature bond method, by which the still warm ductile under layer immediately after extrusion is applied on said woven material of said upper layer fixedly joined within said tissue material.

12. Use of a composite mat (1) according to one of the previous claims as an agricultural product, in particular as a cover of a cow mattress.
